(19) United States
(12) Patent Application Publication
(10) Pub. No.: US 2004/0078248 A1
(43) Pub. Date: Apr. 22, 2004

(54) Method and apparatus for protecting an entity against loss in its valuation

(76) Inventor: Douglas H. Altschuler, New York, NY (US)

Correspondence Address: Guy V. Tucker, 1108 Dwight Way, Berkeley, CA, 94702, US

(21) Appl. No.: 10/448,610

(22) Filed: May 29, 2003

Related U.S. Application Data
(60) Provisional application No. 60/384,198, filed on May 29, 2002.

(51) Int. Cl. G06F 17/60

(52) U.S. Cl. 705/4

(57) ABSTRACT

A method of protecting a company comprises providing an insurance policy to the company, the policy including terms whereby a payout may be paid to the company when the company suffers a predetermined loss in its valuation. The method also comprises receiving a premium from the company and providing a payout to the company when the company undergoes the predetermined loss in its valuation. The method may also comprise performing a situational analysis and purchasing stocks and/or stock derivatives based on the situational analysis. A data processing system for use in administering the insurance policy to protect a company from a loss in its valuation is also disclosed.

This application claims the benefit of U.S. Provisional Application No. 60/384,198, filed on May 29, 2002, which is incorporated herein by reference in its entirety.

### BACKGROUND

The present invention relates to protecting an entity, such as a company, against loss, such as a loss arising as a result of information that is perceived to be negative.

A company's financial strength is often related to and at least partially based on the perception of individuals outside the company. For example, a company whose stock is publicly traded has a worth, or valuation, that is determined at least in part by the company's stock price at any given time. The stock, which is generally available for purchase or sale to anyone not having inside information about the company, has a price that is determined by supply and demand. When there are more buyers than sellers of the stock, buying pressure drives the price of the stock up, and conversely, when there are more sellers than buyers, selling pressure pushes the stock price lower. Companies routinely release information to the public, and frequently, if it is regarded as being of significance, the stock price will fluctuate as a result, depending on whether the public perceives the information to be positive or negative. Additionally, a third party may release information that indirectly affects the price of the company's stock. A privately held company's financial strength may also depend on outsider perception. For example, private investors and/or credit agencies may base the terms of investments or loans made to the company on a perception they have of the company.

The release of information that is perceived by the investment community to be negative may have a devastating impact on a company. For example, if the information is such that it suggests the company will not successfully complete a project, the stock price may fall to a level where the project is no longer factored into the company's worth. In some cases, a company may be unjustifiably penalized by negative information. For example, investors may over-react to negative information and selling momentum may be built up such that the stock drops to a level that is significantly lower than a price commensurate with the released information. Over-selling of the stock can adversely affect the company, such as by forcing large-block or institutional investors to remove the stock from their portfolio and by reducing the morale of employees of the company, particularly if the employees enjoy stock-related benefits from the company.

The financial strength of some companies is limited by the perceived riskiness of their business. For example, the mere possibility that negative news could be released is enough to prevent some individuals from investing in a company. Many investors are unwilling to take on such risks, and will not purchase stock in such a company. In these cases, the company's valuation is determined almost solely by a small segment of the investing community, as the more conservative segment shies away.

Companies whose products require a lengthy development process are particularly susceptible to stock fluctuations based on information concerning the development process. For example, some companies that produce medical devices, pharmaceuticals, and biotechnology products and services are considered risky because their valuations greatly fluctuate depending on the progress of the developments. The potential for very large product revenues generate investor interest, but the clinical trials and regulatory approval process are very arduous. Thus, there are many opportunities for negative information to be released and there is always the possibility that a product will not make it to the market place. Sometimes a company has difficulty maintaining its stock price during this development process, particularly when negative information is released about a particularly high profile product or a product that may, if approved, account for a significant portion of a company's valuation. In extreme situations, perceived negative information can drive a company out of business.

Therefore, it is desirable to be able to protect a company from losses that can affect the company's financial strength. It is further desirable to protect a company from losses that result from negative information. It is further desirable for a company to be able to reduce the risks associated with making an investment in the company.

### SUMMARY

The present invention satisfies these needs. In one aspect of the invention, a method and apparatus are provided which may be used to protect a company or other entity against a loss in its valuation.

In another aspect of the invention, a method of protecting a company comprises providing an insurance policy to the company, the policy including terms whereby a payout may be paid to the company when the company suffers a predetermined loss in its valuation; receiving a premium from the company; and providing a payout to the company when the company undergoes the predetermined loss in its valuation.

In another aspect of the invention, a method of protecting a company comprises providing an insurance policy to a company, performing a situational analysis on the company and using the results of the situational analysis to make investments, and providing a payout to the company when the company undergoes a predetermined loss in its valuation.

In another aspect of the invention, a method of protecting a company comprises providing an insurance policy to a company, performing a situational analysis, receiving a premium from the company, purchasing stocks and/or stock derivatives related to the company, and providing a payout to the company when the company undergoes a predetermined loss in its valuation.

In another aspect of the invention, a method of protecting a company comprises providing an insurance policy to a company, performing a situational analysis, determining the amount of potential payout, purchasing one or more puts in the company, and providing a payout to the company when the company undergoes a predetermined loss in its valuation.

In another aspect of the invention, a method of providing protection for a company comprises offering an insurance policy to a company, the policy including terms providing the company with a payout when the company undergoes a predetermined loss in its valuation, determining a first valuation of the company, determining a second valuation of the company, the second valuation being associated with a negative event, determining a potential payout using the first and second valuations, and purchasing puts associated with the company.

In another aspect of the invention, a data processing system for use in administering an insurance policy to protect a company from a loss in its valuation comprises means for inputting one or more values associated with the terms of the policy, at least one of the values being a predetermined amount of a loss in the company's valuation; means for determining a premium based on the one or more input values, and means for determining when a payout is due.

In another aspect of the invention, a data processing system for use in administering an insurance policy to protect a company from a loss in its valuation comprises means for inputting one or more values associated with the policy, means for inputting one or more values associated with an analysis of the company, means for determining investments to be made using the one or more values associated with an analysis of the company; and means for determining when a payout is due based on a loss of valuation of the company.

In another aspect of the invention, a data processing system for use in administering an insurance policy to protect a company from a loss in its valuation comprises means for inputting one or more values associated with the policy, means for inputting one or more values associated with an analysis of the company, means for determining a premium based on one or more of the values, means for determining a risk mitigating strategy based on one or more values associated with an analysis of the company, and means for determining an amount of payout based on a loss of valuation of the company.

In another aspect of the invention, a method for allowing a company to protect itself against a loss in its valuation comprises obtaining an insurance policy from an insurance provider, the policy including terms whereby a payout may be received when the company suffers a predetermined loss in its valuation; and collecting the payout when the predetermined loss in valuation occurs.

In another aspect of the invention, a method for allowing a company to protect itself against a loss in its valuation comprises obtaining an insurance policy from an insurance provider, the policy including terms whereby a payout may be received when the company suffers a predetermined loss in its valuation as a result of a specific negative event; and collecting the payout when the negative event occurs.

In another aspect of the invention, a method for allowing a company to protect itself against a loss in its valuation comprises obtaining an insurance policy from an insurance provider, the policy including terms whereby a payout may be received when the company suffers a predetermined loss in its valuation; and collecting the payout when the predetermined loss in valuation occurs, the payout being related to the loss in valuation.

In another aspect of the invention, a method for allowing a medical product company to protect itself against a loss in its valuation, the medical product company having one or more products in development, comprises obtaining an insurance policy from an insurance provider, the policy including terms whereby a payout may be received when the company suffers a predetermined loss in its valuation as a result of negative information about a product in development; and collecting the payout when the negative event occurs.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a flow chart schematically illustrating a protection method of the present invention;

FIG. 2 is a flow chart schematically illustrating a process of using the protection method;

FIGS. 3A and 3B are flow charts schematically illustrating alternative processes of using the protection method;

FIG. 4 is a flow chart schematically illustrating another version of a protection method of the present invention;

FIG. 5 is a flow chart schematically illustrating another version of a protection method of the present invention;

FIG. 6 is a flow chart schematically illustrating another version of a protection method of the present invention;

FIG. 7 is a flow chart schematically illustrating a protection providing method according to the present invention;

FIGS. 8A and 8B are flow charts schematically illustrating processes involving a situational analysis that may be used in a protection providing method;

FIGS. 9A and 9B are flow charts schematically illustrating risk mitigating processes that may be used in a protection providing method;

FIG. 10 is a flow chart schematically illustrating another risk mitigating process that may be used in a protection providing method;

FIG. 11 is a flow chart schematically illustrating another version of a protection providing method;

FIG. 12 is a flow chart schematically illustrating another version of a protection providing method;

FIGS. 13A and 13B are flow charts schematically illustrating administration processes for administering a protection providing method;

FIGS. 14A and 14B are flow charts schematically illustrating other administration processes for administering a protection providing method;

FIGS. 15A and 15B are flow charts schematically illustrating other administration processes for administering a protection providing method;

FIGS. 16A and 16B are flow charts schematically illustrating other administration processes for administering a protection providing method; and

FIGS. 17A and 17B are flow charts schematically illustrating other administration processes for administering a protection providing method.

### DESCRIPTION

The present invention relates to protecting an entity against a loss, such as by providing a company with protection against a loss in its valuation. Although the process and apparatus of the invention are illustrated at least partly in the context of protecting companies from losses in their valuation as a result of a negative event, the present invention can be used to protect other entities and in other processes and should not be limited to the examples provided herein.

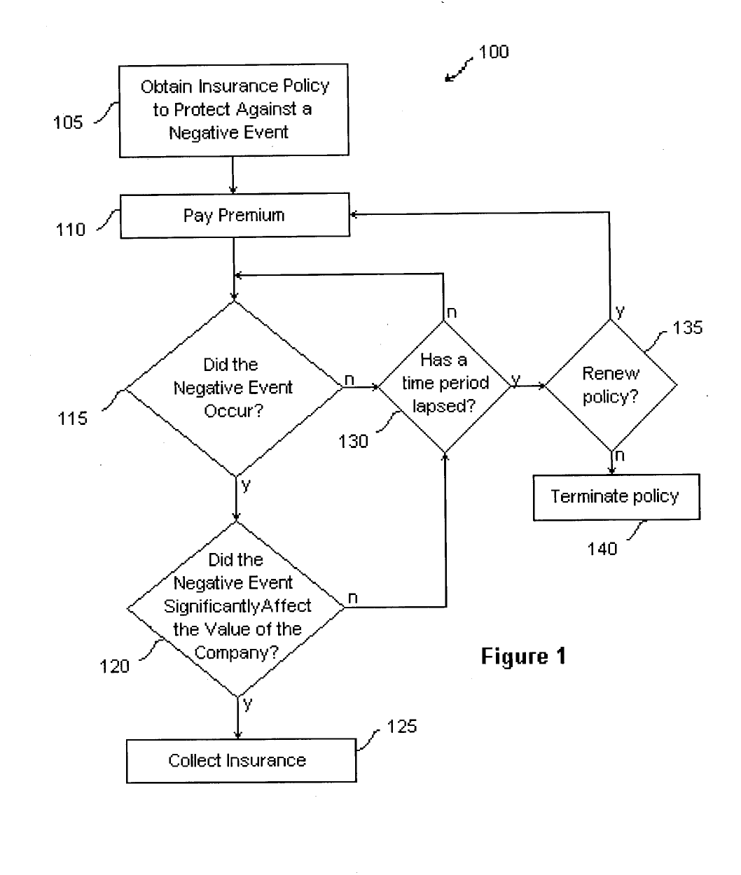

A protection method 100 according to the present invention that allows a company to protect itself from loss is shown in FIG. 1. Using the protection method 100, a company is able to insure itself against a reduction in its valuation. As opposed to a conventional insurance policy where an entity insures an asset for the value of the asset or for a percentage of the value of an asset, the present protection method 100 insures against the loss in perceived value of a company that results from a negative event, such as the release of negative information. For example, a publicly traded company has a valuation determined by its market capitalization, which is generally the stock price of a company at a given time multiplied by the number of the company's outstanding shares of stock. The market capitalization will fluctuate with changing stock price. Thus, the company's value will be reduced when its stock price drops. When a negative event occurs, the stock price will usually drop and will sometimes drop drastically. By using a protection method 100, such as the one shown in FIG. 1, a company can reduce the effects of a negative event.

In using the protection method 100 of FIG. 1, a company obtains an insurance policy 105 from an insurance provider. The insurance provider may be, for example, an insurance company, an individual, a venture capitalist, or other entity. Associated with the insurance policy is a premium and a time period for the policy. After the company pays its premium 110, the insurance policy is in effect throughout its time period. The policy protects the company from the results of a negative event, which may or may not be defined within the policy. The negative event may be any event that adversely affects the value of the company or that may be perceived to adversely affect the value of the company. Accordingly, when a negative event as set forth in the policy occurs 115, the company may make a determination as to whether or not the negative event significantly affected the valuation of the company 120. If it is determined that the loss in valuation is significant as agreed upon by the parties, the company may collect an insurance payout 125 in order to compensate at least partly for the loss. As discussed above, the policy stays in effect until a predetermined time period lapses 130 at which time the company may make a determination as to whether or not the policy should be renewed 135, if a renewal option is within the terms of the policy. If the company decides not to renew the policy, the policy will terminate 140.

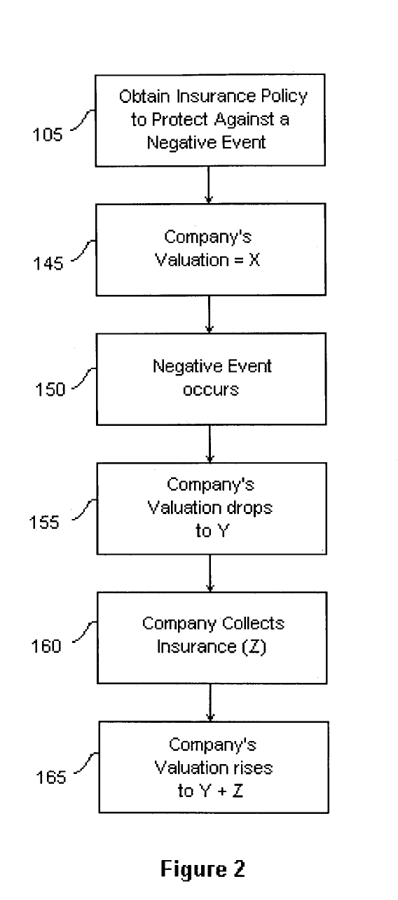

The advantages of a publicly traded company protecting itself with the protection method 100 of the present invention is illustrated in FIG. 2. The company first obtains an insurance policy to protect against a negative event 105. At the time the company purchases the insurance policy or at a time just before a negative event, the company has a valuation 145 of a certain amount, X. Thereafter, the negative event occurs 50. When the public is made aware of the negative event, selling pressure pulls the price of the stock down and the company's valuation drops 155 to a value, Y. If Y is significantly less than X and if the terms of the policy have been satisfied, the company may elect to collect its insurance payout 160 which is a predetermined or calculated amount, Z. This in turn will cause the company's valuation to increase 165 to an amount approximately equal to Y+Z. By being able to counter the negative event with the positive event of collecting insurance, the company can help prevent selling momentum from building and thus can help prevent over-selling of the stock. In addition, a quick rebound from a negative event can sometimes encourage new investment in the company as investors can view strength in the wake of a negative event as a sign of a solid company, making the lowered stock price appear to be a good buying opportunity.

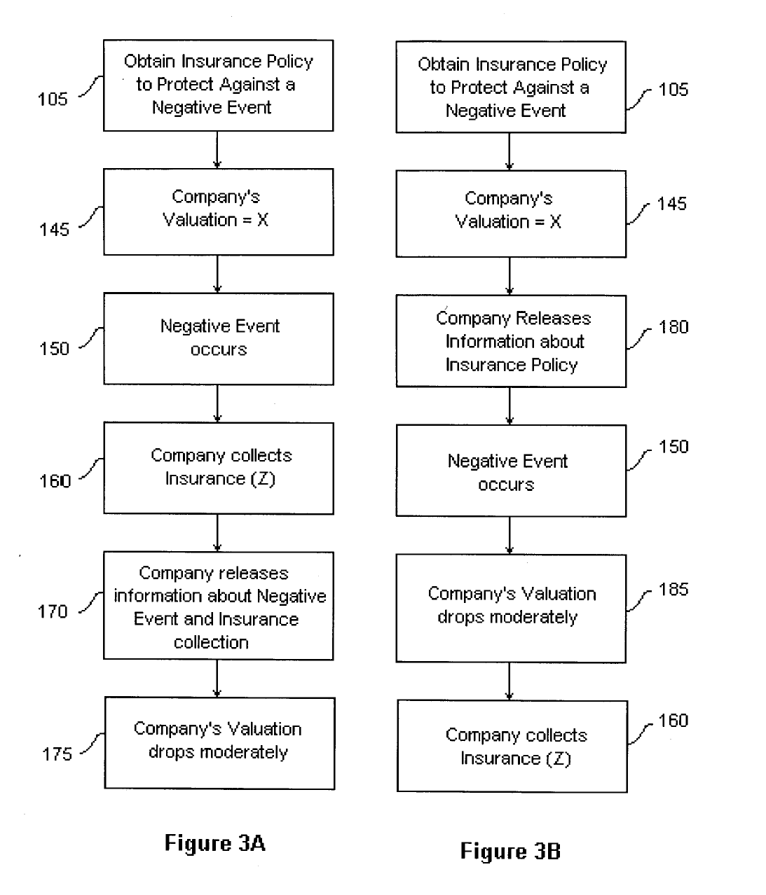

FIGS. 3A and 3B illustrate additional ways the protection method 100 can be used to help secure the financial strength of a company. In the method shown in FIG. 3A, the company obtains an insurance policy 105 and the negative event occurs, as in FIG. 2. However, in this version, the company collects the insurance payout 160 before the news of the negative event is made public. In this way, the company may simultaneously release the negative information and the positive information 170. The company's valuation would then theoretically drop 175 to a value that is approximately the same as the ultimate valuation 165 in the method of FIG. 2. However, in the version of FIG. 3A, the drop would be a more gentle drop, rather than a large drop with a subsequent rise, and the stock would be perceived to be less volatile. Alternatively, the positive news may comprise merely the announcement that the company has an insurance policy. In the version of FIG. 3B, after obtaining the insurance policy 105, the company releases information about having obtained the insurance policy 180. Then, after the news of the negative event 150, the stock drops to a value approximately equal to the values in 165 and in 175 since the investors are aware of the presence of the insurance policy and can factor that into the determination of the company's value. The method of FIG. 3B has the additional advantage of encouraging conservative investors to purchase the stock before a negative event occurs since the conservative investor would realize that the insurance policy would mitigate the risks associated with the stock.

Similarly, a privately held company can benefit from the protection method 100.

For example, a private investor may be more willing to invest in the company if there are assurances against significant loss. In addition, a creditor may be more will to offer better loan rates and amounts since the protection method 100 will provide the company with income even if there is a negative event.

The terms of the policy may be adjusted to suit the needs of the company. For example, the negative event may be defined as a specific event, a general event, or any event that adversely affects the valuation of the company. The policy may also include the manner and the amount of the insurance payout. Accordingly, the premium and other terms may be dependent on the specifics of the policy that the company obtains.

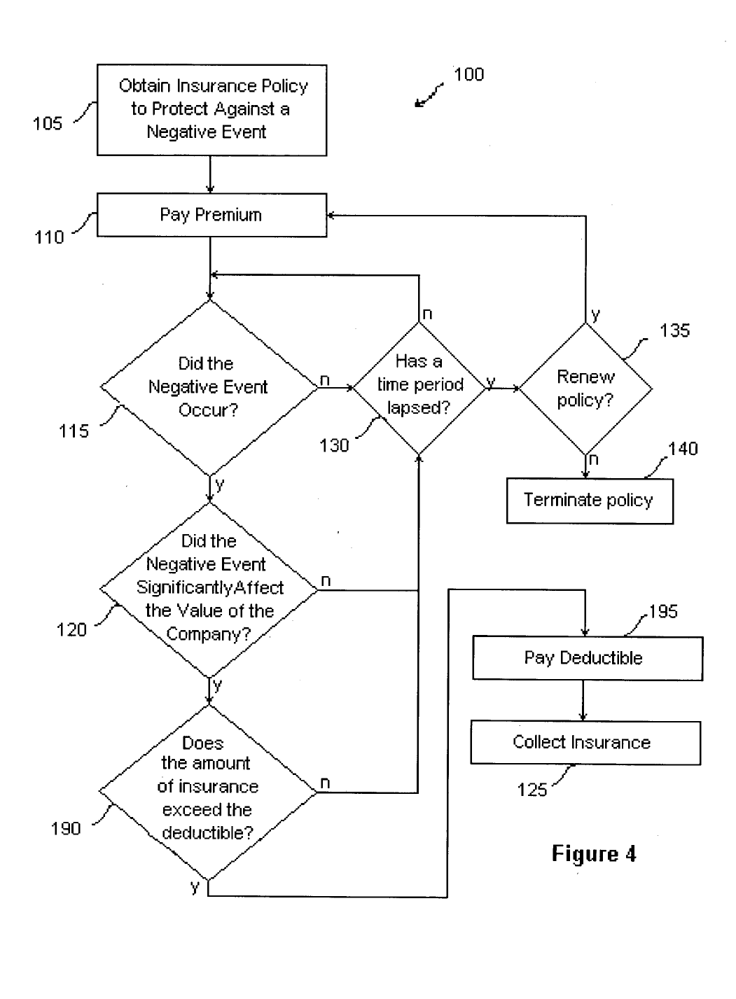

In one version, the protection method 100 may include a payout restriction. For example, in the version shown in FIG. 4, the protection method is similar to the version of FIG. 1, but includes a policy where the company is obligated to pay a deductible before collecting an insurance payout. By electing to pay a deductible, the company may be able to reduce the amount of the policy's premium 110. In this version, after it has been determined that the negative event significantly affected the company's valuation 120, the company must make the further determination of whether or not the insurance payout exceeds the deductible amount 190. If it does, the company would elect to pay the deductible 195 and then collect the insurance 125.

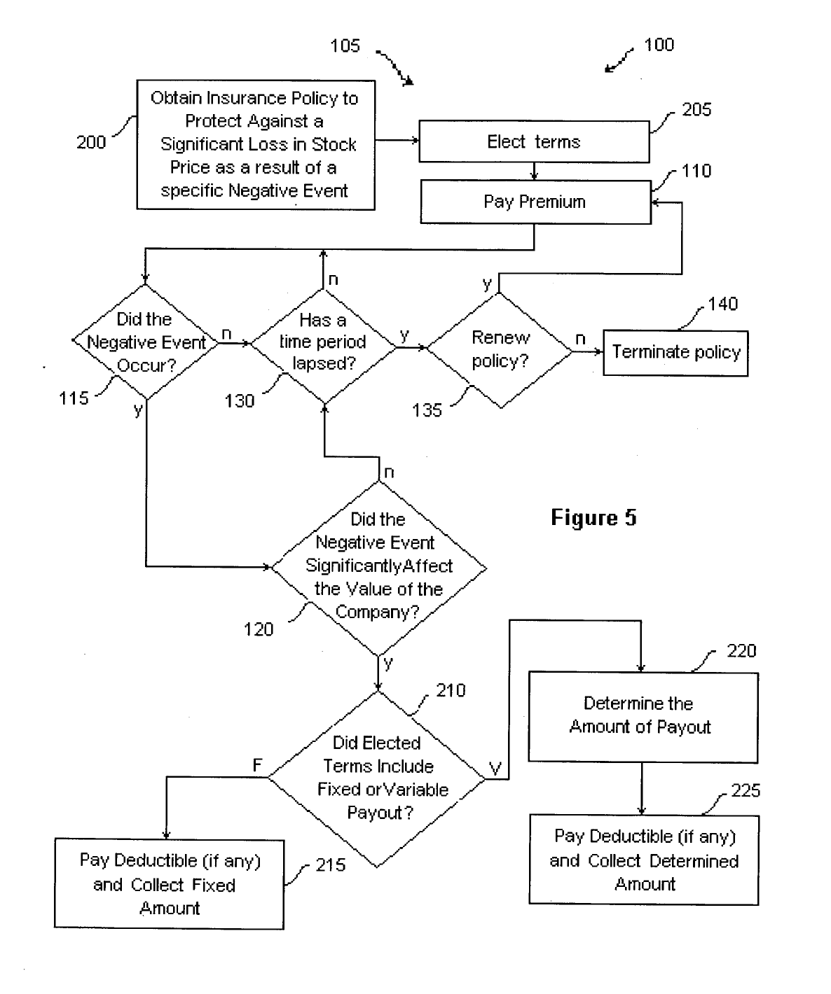

Additionally or alternatively, the protection method 100 may include a specific definition of the negative event and may define the manner of payout if the negative event occurs. For example, FIG. 5 illustrates a version of the protection method 100 where the step of obtaining an insurance policy 105 includes the steps of specifically defining the negative event 200 and determining the terms 205 associated with the negative event. After the occurrence of the defined negative event 115 and after it is determined that the negative event significantly affected the company's valuation, the terms previously elected 205 are used to determine the insurance payout. For example, as shown in step 210, if the terms included that the payout would be a fixed amount, then the company would receive the fixed amount 215. On the other hand, if the terms include a variable payout, such as a payout that is related to the loss in valuation then the amount of payout is determined 220 and then paid out 225.

The negative event may be any event that affects the valuation of an entity, such as a publicly traded or a privately held company. For example, the negative event may be any event that results in information being given to the public, the information being perceived as being bad for the entity. The information may be released by the entity, may be released by a third party, or may be otherwise placed in the public domain. The information may include rumors and innuendos. Examples of a negative event include but are not limited to information related to the development of a product or service, information related to the regulatory approval of a product or service, information related to a legal action, information related to a federal investigation into the practices of the entity, such as Internal Revenue Service, Securities and Exchange Commission, and/or Department of Justice investigations and outcomes, Government reimbursement issues, information related to liabilities of a product or service, and the like.

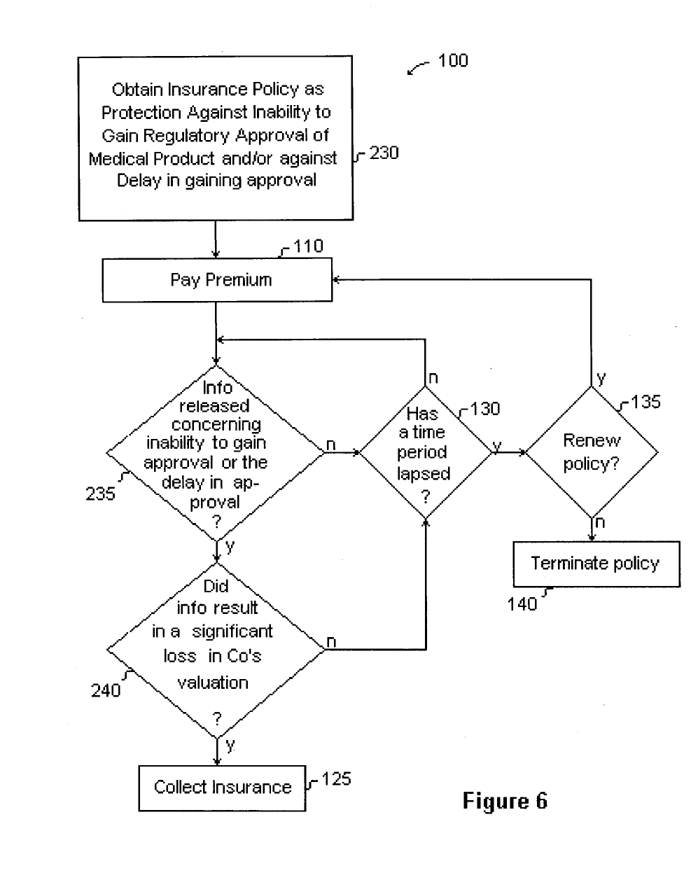

In one version, the protection method 100 may include an insurance payout that is dependent on the specifics of the negative event. A specific example of an event related protection method is shown in FIG. 6 where the negative event is related to the development of a medical product. As discussed above, the lengthy medical product development process is prone to many opportunities for the release of negative information. For example, a company must first undergo clinical testing of the product to gather information on the safety and effectiveness of the medical product. The release of any information that may indicate that the product is less than perfectly safe or effective may cause a reduction in the value of the company. Sometimes the negative information will be released by the company and will suggest that the product development is being cancelled. As a result, the stock price will generally be reduced to a point where the valuation of the company no longer accounts for the possibility of eventual revenues from the product. In another situation, a company may release information indicating that the development of the product is delayed. In this case, the valuation of the company will usually be adjusted to account for the delay and may even be further reduced if the investment community perceives the delay as reducing the likelihood of eventual approval of the product. In addition, information released from a third party may constitute a negative event. For example, a competing company may release positive information about a competing product or a competing company could release information concerning its intellectual property either of which may result in a lessening of the value of the company's products and/or intellectual property. Investors may view this news as a possibility for loss of market share for the first company's product, and the first company's value may be reduced. Also, a regulatory agency may release information that directly or indirectly affects the likelihood of approval of a particular product, and this information may be a negative event. These negative events can be mitigated by using a protection method 100, such as the one shown in FIG. 6. In this version, a company that is producing a medical product or service obtains 230 an insurance policy to protect itself against loss of valuation in the event that the product or service fails to gain regulatory approval or in the even the gaining of regulatory approval is delayed. After information is released 235, such as by being released from the company or from a third party, insurance is collected 125 if the information significantly affects the company's valuation 240.

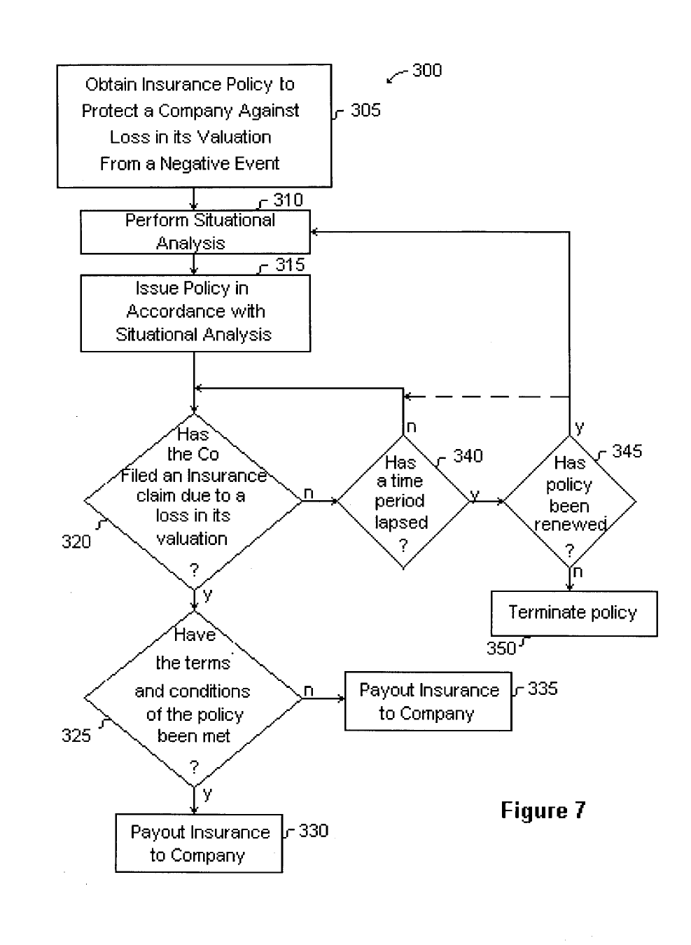

In another aspect of the invention, a protection providing method 300 allows an insurance provider to offer protection of the type discussed above to one or more entities, as shown for example in FIG. 7. The protection providing method 300 incorporates analytical reasoning to increase the probability that the provider will be profitable in the endeavor and to minimize losses when they occur. The protection providing method 300 comprises offering an insurance policy 305 to an entity, such as a company, to protect the company from losses in the company's valuation. Before or after the company obtains an insurance policy, information is gathered so that a situational analysis may be performed 310. The results of the situational analysis are then used 315 to determine the terms of the policy and/or are used by the insurance provider to take any other risk mitigating steps. If the company suffers from a reduced valuation as a result of a negative event 320, the company may file an insurance claim to collect an insurance payout. The insurance provider checks to see if the terms and conditions of the policy have been met 325, and if so will issue the insurance payout to the company 330. If the terms and conditions have not been met, the provider will inform the company of the inapplicability of the claim 335. As discussed above, the insurance policy may be in effect for a predetermined time period 340, after which it may be renewed 345 or terminated 350 if such is within the terms of the policy.

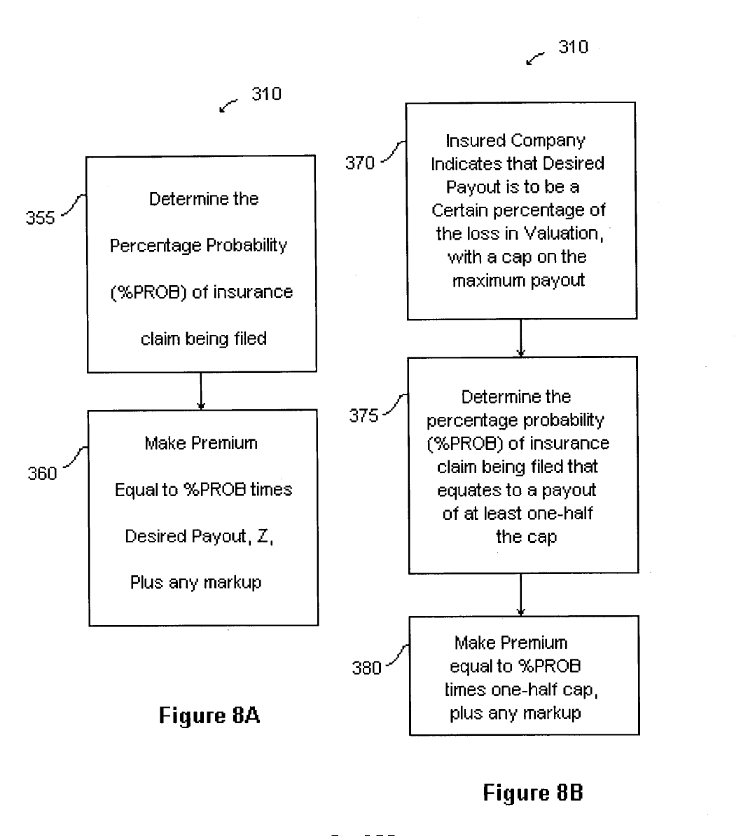

In one version, the result of the situational analysis 315 comprises one or more values or pieces of information that may be used in generating the terms of the insurance policy. For example, the situational analysis may include a determination of the likelihood that a claim will be made on the insurance policy at issue. In a simple form, the resulting value may be a probability percentage (% PROB). Thus, if it is determined that a particular company stands a 30% likelihood of suffering a specified negative event and filing a claim to recover lost valuation, then that policy is assigned a % PROB of 0.30. This % PROB can be used in various ways, such as in the version of FIG. 8A, where the situational analysis 310 comprises determining a % PROB 355 and then using the % PROB to set at least a portion of the terms of the policy. In the version of FIG. 8A, the % PROB may be used to calculate a premium associated with a particular policy. Specifically, the premium may be made an amount equal to the % PROB multiplied by a desired payout, Z, plus any markup to account for overhead, added profit, etc. 360. Accordingly, if the insured company desires a one million dollar payout as protection against a negative event, and if the situational analysis returns a % PROB of 0.30, then the premium would be set at $300,000 plus a markup, if any. In another example, the company purchases an insurance policy that has an insurance payout that is related to the amount of drop in valuation of the company. FIG. 8B illustrates an example of a method where the situational analysis 310 may be used to determine terms of the policy that includes such a variable payout. In this version, the company specifies a percentage of the drop in valuation that is desired to be recovered 370. For example, a company may wish to recover 75 percent of the loss in their market capitalization that occurs as a result of a negative event. Usually, the company will also choose a cap or maximum amount of the payout. A determination is then made as to the % PROB of a payout that equals at least one half of the maximum payout (½ cap) 375. The premium is then determined to be an amount in relation to the determined value. For example in the version shown, the premium is determined to be an amount equal to the % PROB multiplied by (½ cap) plus a markup, if any 380.

The cost of the service to the company can be lowered in a number of ways. For example, by holding down the cost of overhead and/or by providing insurance to a large number of entities thereby distributing the risk over a larger number of companies, the insurance provider can reduce the markup associated with a premium. In addition, by wisely investing the premium and any other collected fees, the insurance provider can offer discounts to the premium. Furthermore, the situational analysis can result in a risk mitigating process that can reduce the company's premium or other costs.

In one version, a risk mitigating process comprises using hedging activities. For example, in one version a risk mitigating process comprises strategically purchasing stocks or stock derivatives based on the outcome of the situational analysis 310 to reduce the losses to the insurer in the event of a payout. Derivatives are stock-related instruments, such as options. Options are contracts giving the holder the right to buy or sell a stock at a given price by a given date. A “put” is an option giving the holder the right to sell a given stock (usually in lots of 100 shares) at a given price by a given date. A “call” or “call option” is an instrument that gives the holder the right to buy a given stock at a given price in a given period. A fee is paid when a put or a call is purchased. In general, a put is valuable when a stock price drops below the given price, and a call is valuable when a stock price rises above its associated given price.

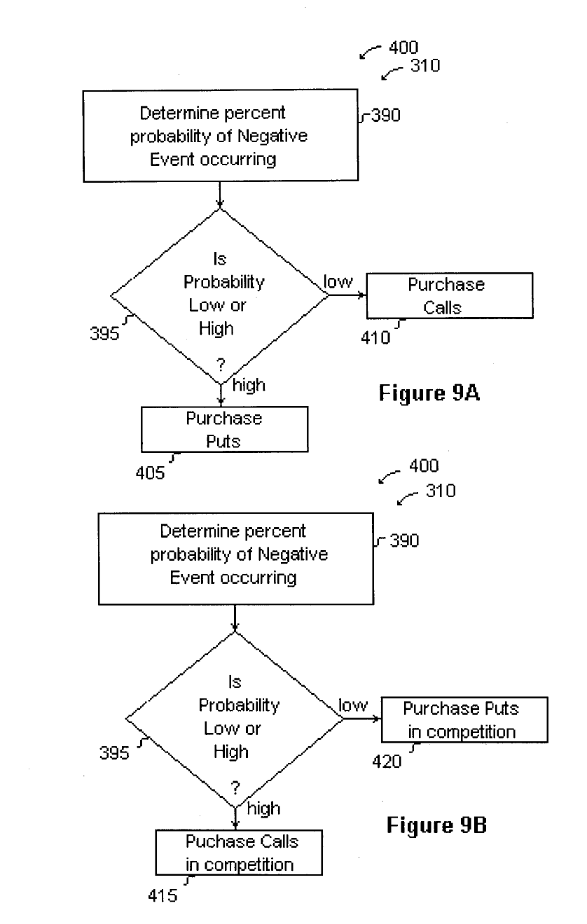

Versions of risk mitigating processes 400 that are derivative-based are shown in FIGS. 9A and 9B. In the version of FIG. 9A, the risk mitigating process 400 comprises determining the percent probability of a negative event occurring 390. Then, it is determined if the probability is low or is high 395. For example, if the percent probability is below a predetermined or input value, such as 30%, 50% or other value, then it may be considered a low probability, and if the percent probability is above a predetermined or input value, such as 70%, 50% or other value, then it may be considered a high probability. A high probability is indicative of a high probability that the stock price will go down. Therefore, in such a case according to this version, the insurance provider would purchase one or more puts 405. Accordingly, if the negative event occurs and the company files a claim to collect an insurance payout, the insurance provider's loss in making the payout is reduced by the amount of gain that is made by the covering puts. Conversely, when there is a low probability of a negative event, then there is increased likelihood that the stock price will increase, and the insurance provider would purchase one or more calls 410. Alternatively or additionally, step 400 may comprise selling put options to a third party and/or step 405 may comprise selling call options to a third party. The version of FIG. 9B is similar to the version of FIG. 9A. However, in this version, the insurance provider purchases calls in the stock 415 of a competitor of the insured company when there is a high probability of a negative event at the insured company. The insurance provider purchases puts in the competitive company when the probability of the insured company having a negative event are low. The theory behind the version of FIG. 9B is that when a negative event hurts one company, it may help a competing company, and vice versa. Another version comprises combining the purchase suggestions in the versions of FIGS. 9A and 9B. In many cases there are other factors and considerations that are weighed before the puts, calls, stocks or stock derivative are purchased.

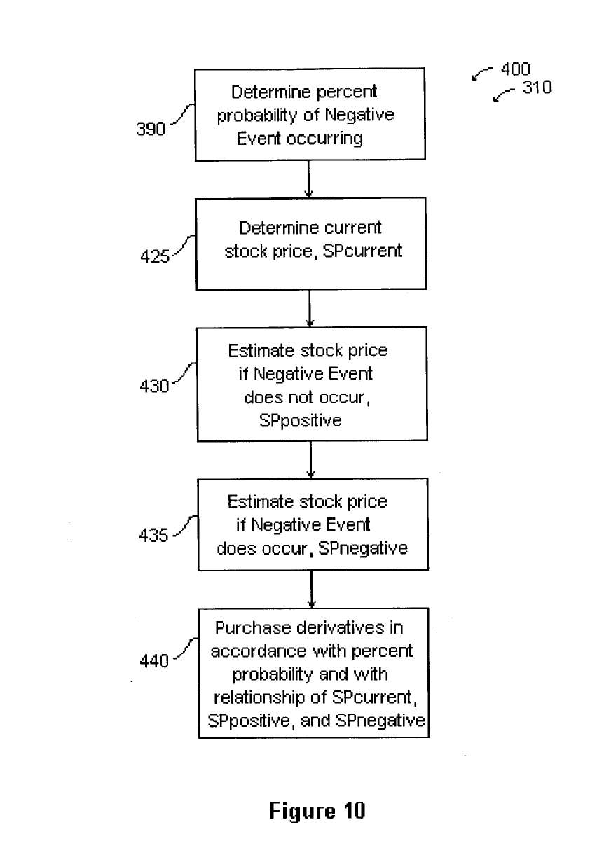

FIG. 10 illustrates another version of a risk mitigating process 400 comprising a situational analysis 310, the results of which are used to strategically purchase and/or sell stocks or stock derivatives. In this version, the situational analysis 310 includes not only an analysis of the negative event probability, but also an analysis of the stock situation. As shown in FIG. 10, the situational analysis 310 comprises determining 425 the current stock price, SP_{current}, estimating 430 the stock price if the negative event does not occur, SPₚₒₛᵢₜᵢᵥₑ, and estimating 435 the stock price if the negative event does occur, SP_{negative}. Then, the stocks or derivatives are purchased in accordance with the percent probability of the negative event and in accordance with the relationship of the current stock price to the estimated stock prices.

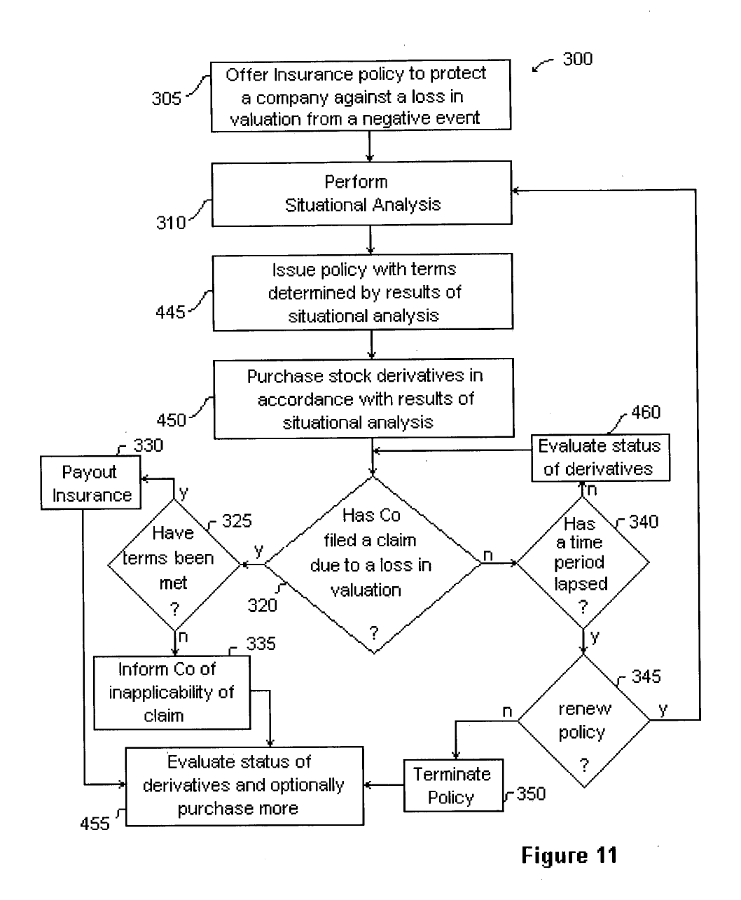

In one version, as shown in FIG. 11, the protection providing method 300 comprises using the results of a situational analysis 310 to both establish the terms of an insurance policy and to mitigate the risks associated with providing the insurance policy. After the policy is offered 305 to a company desiring to protect itself from a loss in valuation, the situational analysis 310 is performed, as discussed above. The policy is then issued 440 with terms derived in accordance with the outcome of the situational analysis 310. For example, step 440 may include one or more of the features discussed in connection with FIGS. 8A and 8B. When the policy is in force, stocks or stock derivatives may be purchased 450 in accordance with the outcome of the situational analysis 310. For example, step 450 may include one or more of the features discussed in connection with FIGS. 9A, 9B, and 10. From this point the protection providing method of FIG. 11 is similar to that of FIG. 7. However, after paying out the insurance to the company 330, informing the company of the inapplicability of a claim 335 or terminating the policy 350 the status of the stocks and/or derivatives is evaluated 455 and the stocks and/or derivatives are bought, sold, or held depending on the evaluation. In addition, periodically during the period of the policy before a claim is made, the status of the stocks and/or derivatives is evaluated 460 in accordance with the results of the situational analysis 310. Optionally, if the policy is renewed 345, a new situational analysis 310 may be performed. Also, the situational analysis 310 may be updated at any time during the protection providing process 300.

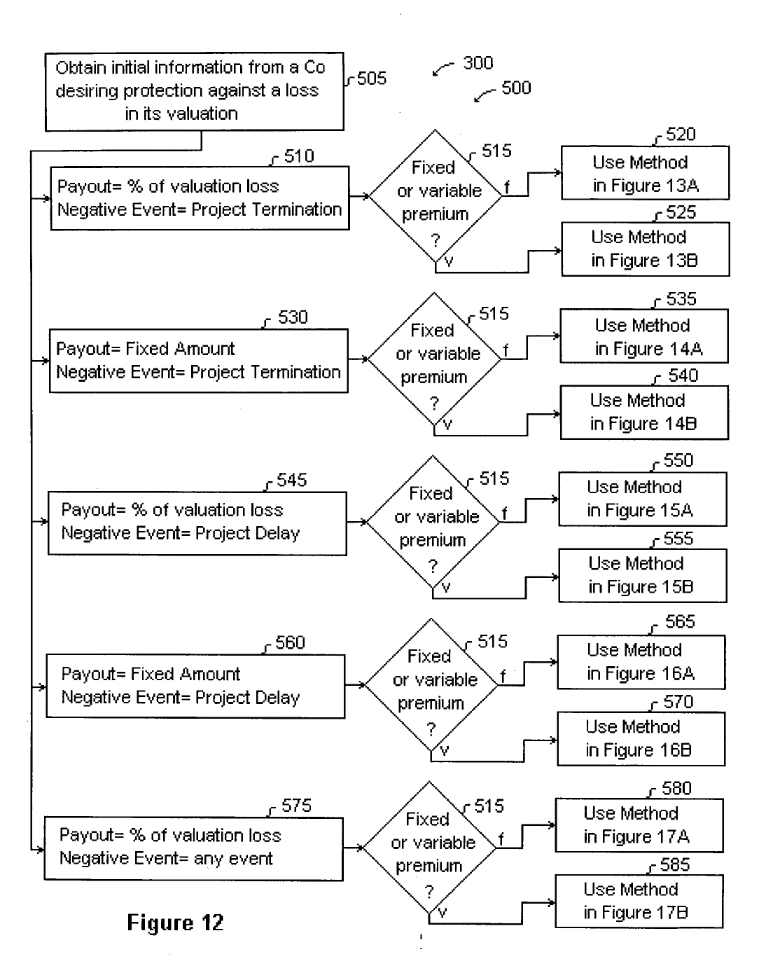

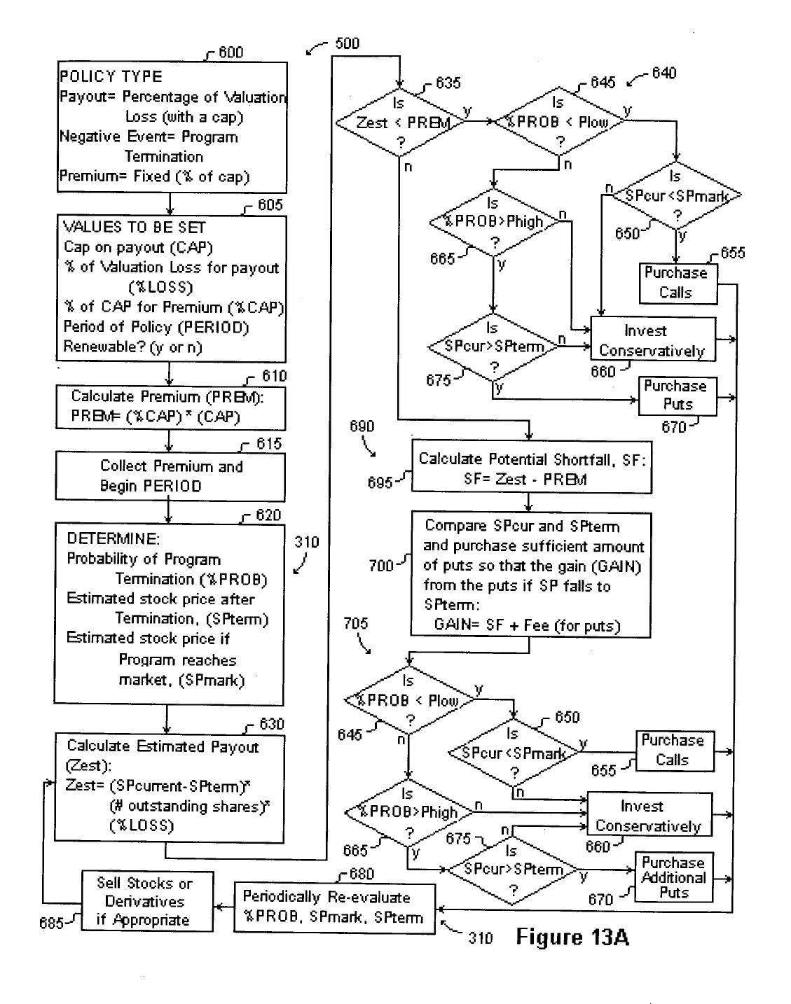

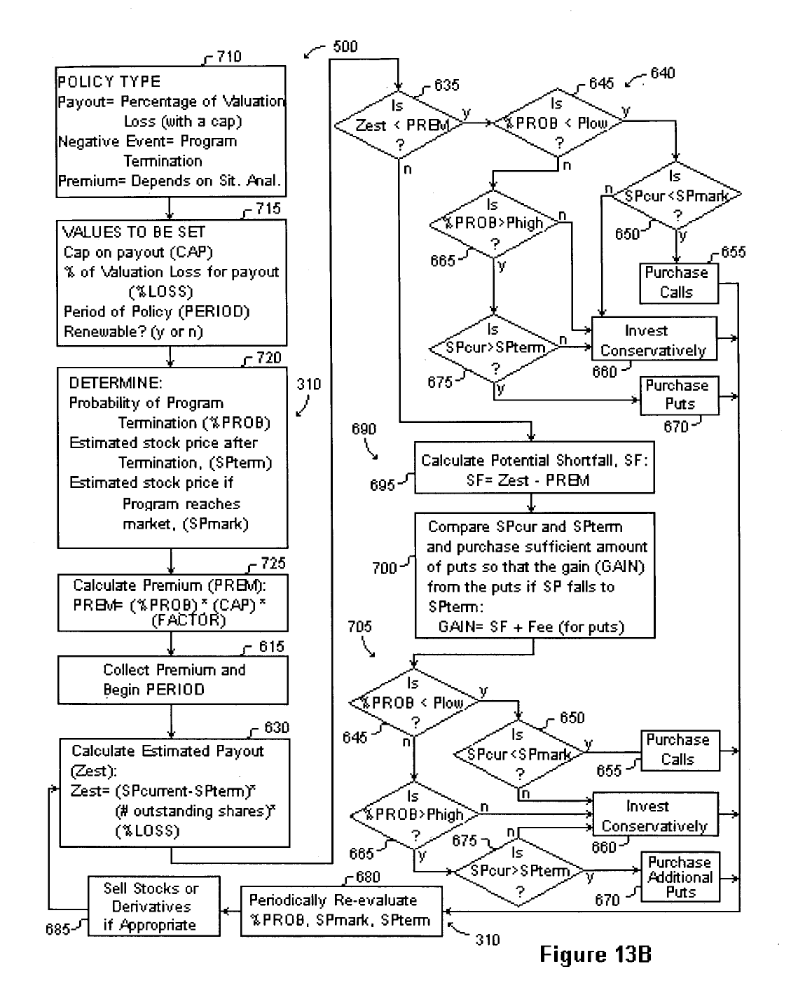

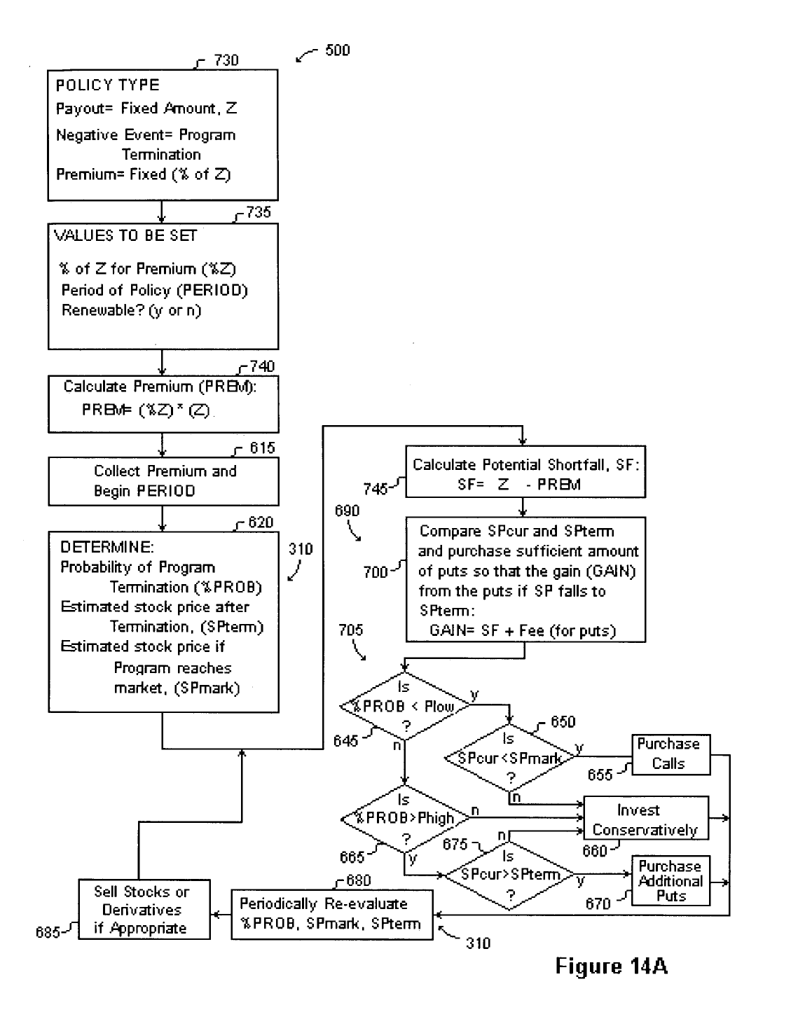

When providing protection by a protection providing process 300 of the invention, the provider may administer the protection in accordance with a protection administration process 500. For example, a version of an administration process 500 is shown in FIG. 12. In this version, the administration process 500 comprises obtaining initial information 505 from a company desiring to purchase protection against a loss in its valuation. An example of some initial information is shown in box 510. In this example, the company desires an insurance payout that is related to the loss in valuation, such as by being a certain percentage of the loss in valuation, and desired the negative event to be the termination of a particular project, such as the failure of a product to reach the market place. In addition, the company may indicate whether they prefer to have a fixed premium or a variable premium 515. For example, a fixed premium may be a premium that is determined solely in relation to a potential payout, or a maximum potential payout, and a variable premium may be derived in accordance with a situational analysis 310, as discussed above. If a fixed premium is desired, the administration process 500 continues as shown for example in FIG. 13A. If a variable premium is desired, the administration process 500 continues as shown for example in FIG. 13B. Other examples of sets of initial information 530, 545, 560, 575 have associated exemplary administration process continuations 535, 540, 550, 555, 565, 570, 580, 585, as shown in FIG. 12.

FIG. 13A illustrates a version of at least a portion of the administration process 500 for an insurance policy where the insured company desires that the payout be a percentage of the valuation loss after a negative event that involves the termination of a program and with a premium that is fixed, such as by being a certain percentage of the maximum payout 600. Certain values and/or terms associated with the policy are then set 605. For example, the insured company may select the maximum amount of the payout (CAP). Since with this policy the premium is a function of the CAP, the insured company can, for example, set the CAP based on the premium it can afford. Also to be determined and set is the amount of the payout, such as by determining the percentage of the valuation loss (% LOSS) that will make up the payout. For example, in one version it may be determined that the % LOSS will be 50%. If the insured company then terminates a program and suffers a loss in valuation as a result, then the company may collect a payout equal to 50% of the loss. The precise definitions of what makes up a loss may of course be contractually agreed upon. In addition, the percentage of the cap (% CAP) that makes up the premium must be determined or set. In one version, this % CAP is determined by the insurance provider. The period of the policy (PERIOD), such as 1 month, 6 months, 1 year, 2 years, 3 years, etc. is also agreed upon and set, as is the renewability of the policy.

In the version of FIG. 13A the administration continues in accordance with the policy type 600 and with the values and terms that are set 605. The premium, PREM, is calculated 610, for example by being: PREM=(% CAP)*(CAP). The insured company then pays the insurance provider the calculated premium 615 and the period of the policy, PERIOD, begins.

After or before the period begins, a situational analysis 310 is performed. The situational analysis may include any of the features described above. In the version shown in FIG. 13A, the situational analysis 310 comprises determining 620 the probability of program termination, % PROB, the estimated stock price in the event of such termination, SPₜₑᵣₘ, and the estimated stock price if the program results in a product or service that reaches the market or otherwise reaches its objective, SPₘₐᵣₖ. Based on these determinations, an estimation can be made 630 as to the amount of a potential payout in the event of the program termination. For example, this amount can be estimated by estimating the decrease in market capitalization that would occur. To make this estimation, SPₜₑᵣₘ is subtracted from the current stock price, SP_{current}. That difference can be multiplied by the number of shares outstanding and by % LOSS to get the payout estimation, Zₑₛₜ. If the calculated Zₑₛₜ is greater than the CAP, then Zₑₛₜ may be considered to be equal to the CAP. In another version, the loss in valuation may be based on a loss that occurs relative to a particular date, such as the date that the policy takes effect. In that case the stock price on that date would be substituted for the SP_{current} in the Zₑₛₜ calculation.

If the Zₑₛₜ is less than the collected PREM 635, then the insurance provider does not risk a shortfall, assuming the situational analysis and determinations are accurate. Accordingly, there is little risk to the provider. The provider may still want to use the gathered information to the provider's advantage. Therefore, if Zₑₛₜ is less than the collected PREM then the provider may wish follow an investment method 640 with which the collected premium and/or additional funds may be invested. In the investment method 640 version shown in FIG. 13A, it is first determined if the % PROB is low or high. This can be done by having a predetermined value or settable value for a percentage (P_{low}) below which % PROB would be considered “low”. If % PROB is less than Plow 645, and if the current stock price is less than SPₘₐᵣₖ 650, then the provider may wish to invest in the company. In a particular version, if the current stock price is significantly less that than SPₘₐᵣₖ, then the provider may purchase calls in the company 655. If the comparison of the stock prices do not warrant the purchase of derivatives, more conservative investing 660 may be prudent. Examples of conservative investing may include but not be limited to investing in one or more of certificates of deposit, bonds, treasury bills, mutual funds, stocks and/or stock derivatives not associated with the insured company, and stocks and/or stock derivatives associated with the insured company. If % PROB is not less than P_{lOW}, it may be higher than a P_{high}, indicating the there is a high probability of product termination. When the % PROB is determined 665 to be sufficiently high, puts may be purchased 670 in the insured company if the price of the stock warrants 675.

Additionally or alternatively, step 655 may comprise selling puts in the insured company, purchasing stocks and/or calls in a competitor, or similar activities, and step 670 may comprise selling calls in the insured company, selling stocks and/or puts in a competitor, or similar activities. Thoughout the period of the policy and optionally after the period of the policy, the statistical analysis 310 and the investment situation may be periodically re-evaluated 680 and any necessary actions may be taken 685. The periodic re-evaluation may be performed at any desirable interval of time, such as monthly, daily, or continuously.

If the Zₑₛₜ is not less than the collected PREM 635, then the insurance provider takes on a risk of a shortfall if the negative event occurs and a payout must be made. Accordingly, in one version of the invention, the provider may take on a process 690 to reduce or eliminate the risk. For example, one version of such a process 690 is illustrated in FIG. 13A. First, the potential shortfall, SF, is calculated 695 by subtracting the premium, PREM, from the estimated payout, Zₑₛₜ. Then the provider may purchase puts in the company to account for the shortfall and for the fee for the puts 700 in the event of a payout. To do this, the provider may consider the current strike price for the puts and determine how may puts would need to be purchased so that if the stock price fell to SPₜₑᵣₘ the puts would provide income equal to the shortfall plus the fee for the puts. The provider may then also follow an investment method 705, which may be similar to the investment method 640 discussed above.

With the administration method 500 shown in FIG. 13A, the provider is assured of a non-losing endeavor if the situational analysis is accurate. As can be seen, if there is no claim filed within the life of the policy, the provider will have a revenue given by the PREM minus the fees associated with the purchase of puts in step 700, if any, plus any investment income in steps 640 and 705. If there is a claim, the PREM and the income from the puts in step 700 would roughly equal the payout, and the provider would have revenue given by any investment income from steps 640 and 705.

The situational analysis 310 and/or the selection of values and terms may be performed in a manner that reduces the likelihood of the provider suffering a loss. In one version, a team of one or more experts in a particular field may be assembled. For example, a pharmaceutical product team may comprise members that are experts in medicine, chemistry, and/or regulatory matters. A legal issues team may comprise members that are experts in particular legal fields. Each of the teams may also comprise one or more experts in business and finance. Alternatively or additionally, the provider may insure a statistically significant number of companies to spread the risk out and reduce the importance of an accurate analysis in every instance. In another version, the values that are to be set, such as the % CAP, P_{low}, P_{high}, may be set conservatively or aggressively to match the level of risk that the provider is willing to take on. For example the values may be set conservatively if only a few companies are insured and may be set more aggressively if several companies are insured or if the analyses have proven to have a high success rate.

FIG. 13B illustrates a version of at least a portion of the administration process 500 for an insurance policy where the insured company desires that the payout be a percentage of the valuation loss after a negative event that involves the termination of a program and with a premium that is dependent on the outcomes of the situational analysis 710. This policy differs from the policy administered in FIG. 13A in that the premium is not a fixed percentage of the maximum payout, but is instead tied to the riskiness of the policy. This type of policy may allow the insurance provider to place further emphasis on the situational analysis, if desired, and allows for potentially greater revenue if the situational analysis is accurate. The values to be set or determined 715 are similar to those in step 605 of FIG. 13A, except that in this version there is no need for the % CAP value. Also, there may be no CAP associated with the policy in some situations. The situational analysis 310 is then performed. In this version, the situational analysis 310 comprises determining 720% PROB, SPₜₑᵣₘ, and SPₘₐᵣₖ, much like in step 620. However, as discussed above, this determination 720 is performed before the calculation of premium 725 and the % PROB is used in calculating the premium, PREM. For example, in one version, the premium may be calculated by multiplying the % PROB by the CAP. Alternatively, such as when there is no CAP, the premium may be calculated by multiplying the % PROB by Zₑₛₜ. In either case, the calculation may also include a factor, FACTOR, in the calculation by which the insurance provider may adjust the premium up or down. The administration process 500 of FIG. 13B may then continue in much the same manner as in FIG. 13A.

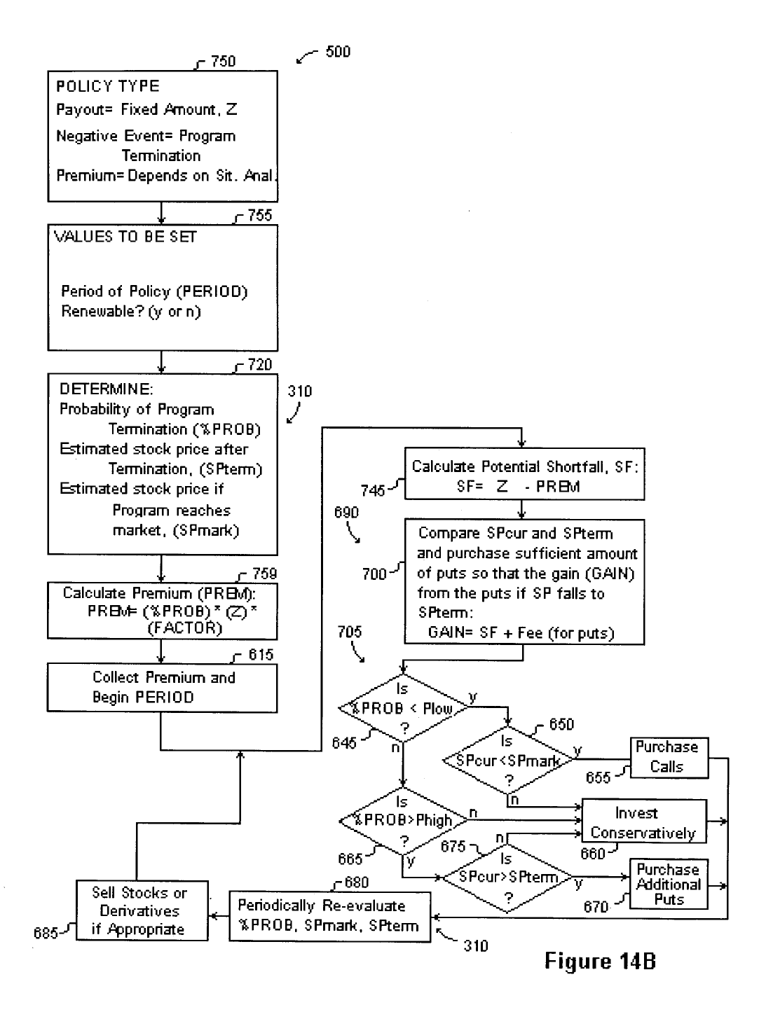

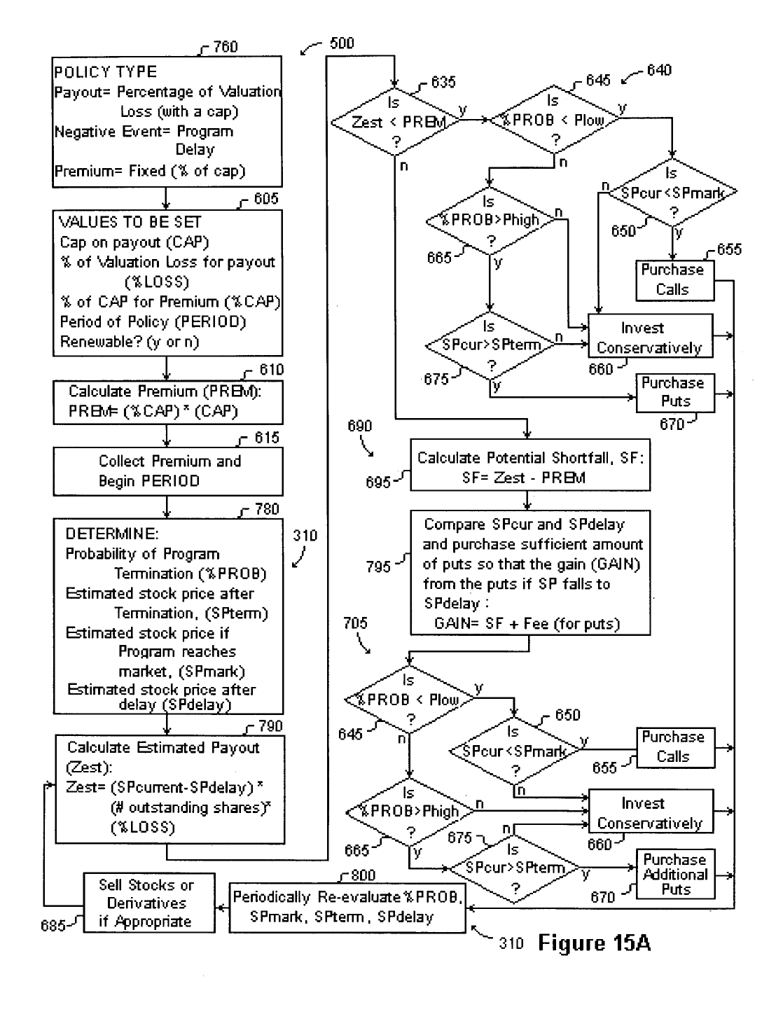

An exemplary administration process 500 for a policy 730, 750 that has payout that is a fixed amount is shown in FIGS. 14A and 14B. FIG. 14A is similar to the process described in FIG. 13A except that the payout, Z, is known and therefore does not need to be estimated. Accordingly, the values to be set or determined 735 do not include a CAP and a % LOSS, and the values include a % Z for the premium instead of a % CAP. The premium may then be determined 740 based on the % Z and the known Z. The process then may continue as in FIG. 13A, but with the potential shortfall, SF, determined 745 by subtracting the premium from the known payout, Z. The process shown in FIG. 14B is similarly like the process of FIG. 13B. The values to be set or determined 755 in this version do not necessarily include the CAP and the % LOSS, and the calculated premium 759 uses the known payout, Z, instead of the CAP or estimated payout.

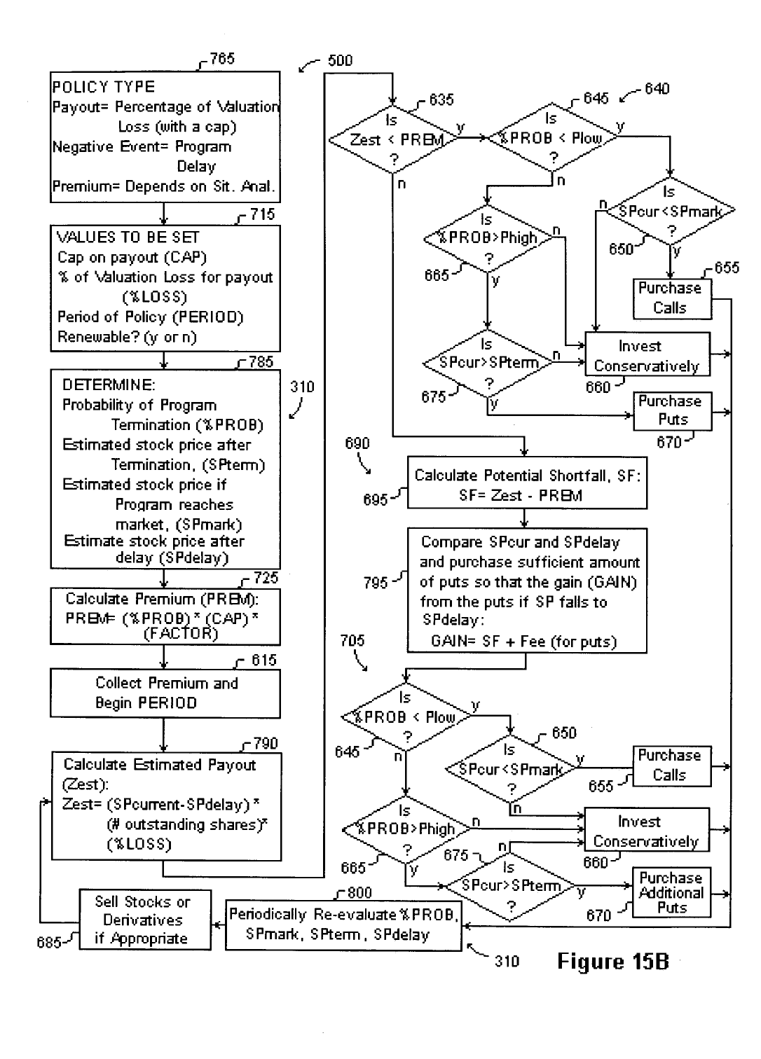

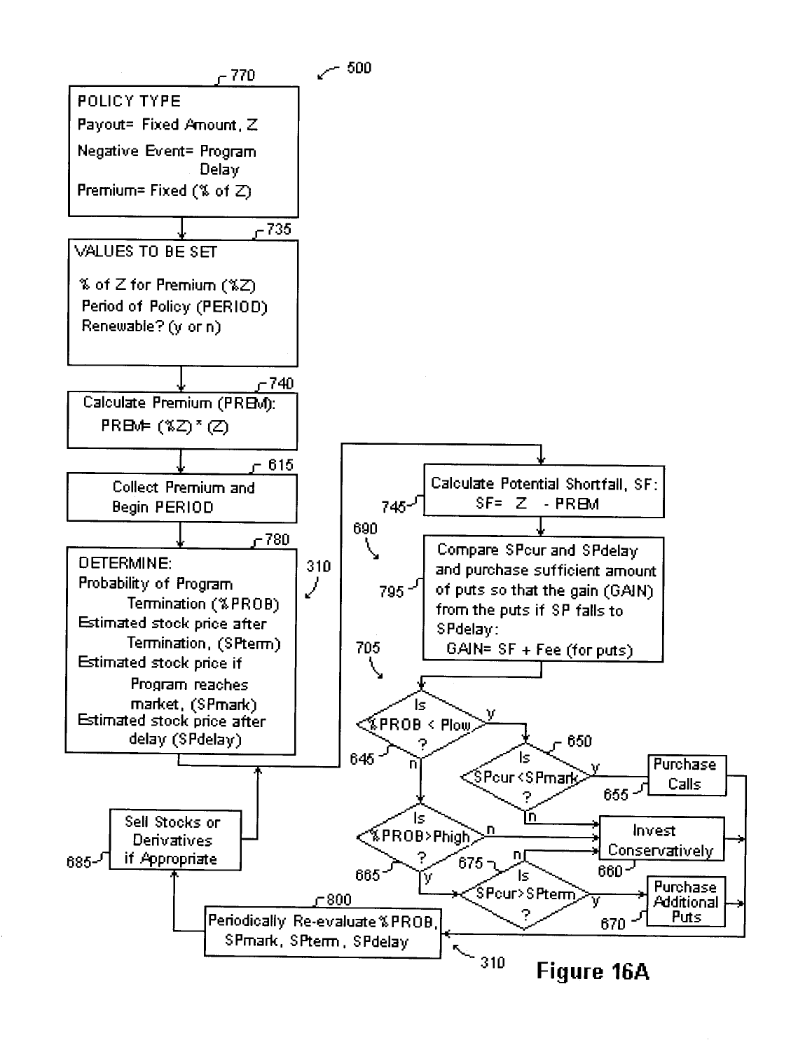

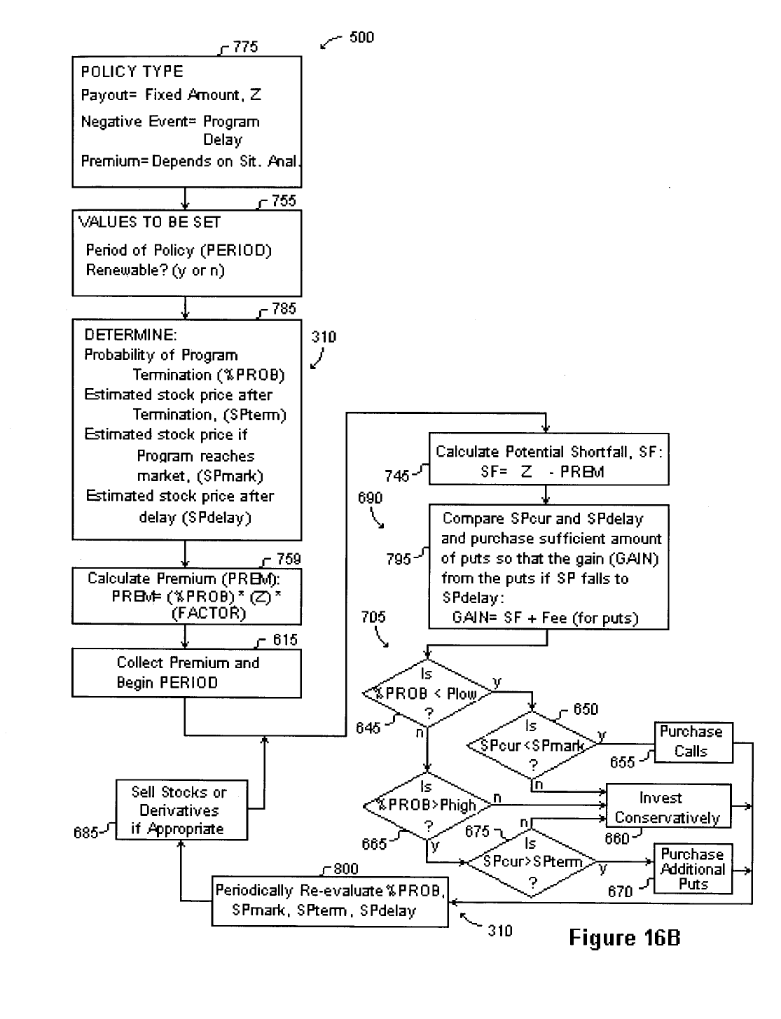

As discussed in connection with FIG. 12, some insurance policies may be based on a negative event that is merely the delay in a program, rather than in the termination of a program. For example, in the medical product industry, some products are delayed during their development for the purpose of gathering more clinical data and/or to meet regulatory requirements. When news of the delay reaches the investor community, the company's valuation may drop in relation to the lost potential revenues that would have resulted from the program. In many cases the valuation may drop further as an investor may view the delay as an indication of the ultimate termination of the program. Accordingly, a policy may be provided that protects a company from a delay-related loss in valuation. FIGS. 15A, 15B, 16A, and 16B illustrate administration processes 500 for such policies. The processes shown in FIGS. 15A, 15B, 16A, and 16B are similar to the processes shown in FIGS. 13A, 13B, 14A, 14B, respectively, except the policies 760, 765, 770, 775 are for the negative event being a delay in a program rather than in a program termination. In some instances, the insured company may obtain a policy that protects against both a delay and a termination. In the versions of FIGS. 15A, 15B, 16A, and 16B, the situational analysis 310 associated with the policy administration includes a determination 780, 785 of an estimation of the stock price if a delay occurs, SP_{delay}. The calculated Zₑₛₜ 790 in this version is based on the SP_{delay}. Also, the puts purchased 795 to make up for a potential shortfall are purchased to cover the payout based on the delay. The investment strategies may remain based on the % PROB of program termination since that is the ultimate value of the insured company. The periodic re-evaluation 800 would also include a re-evaluation of the SP_{delay}.

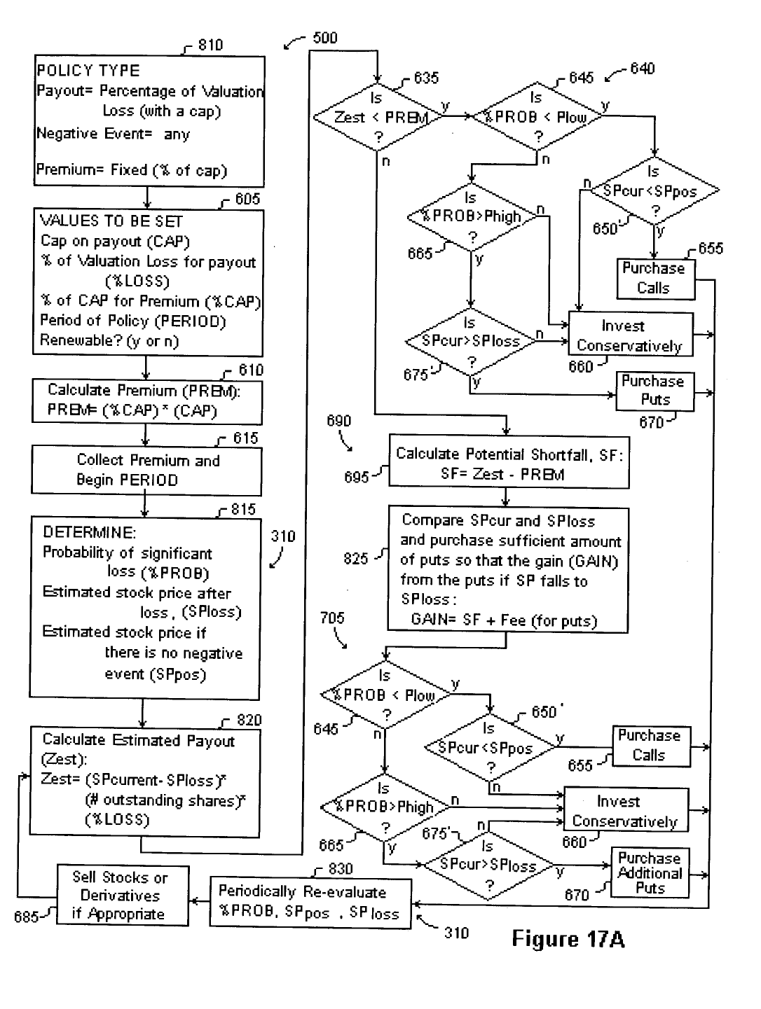

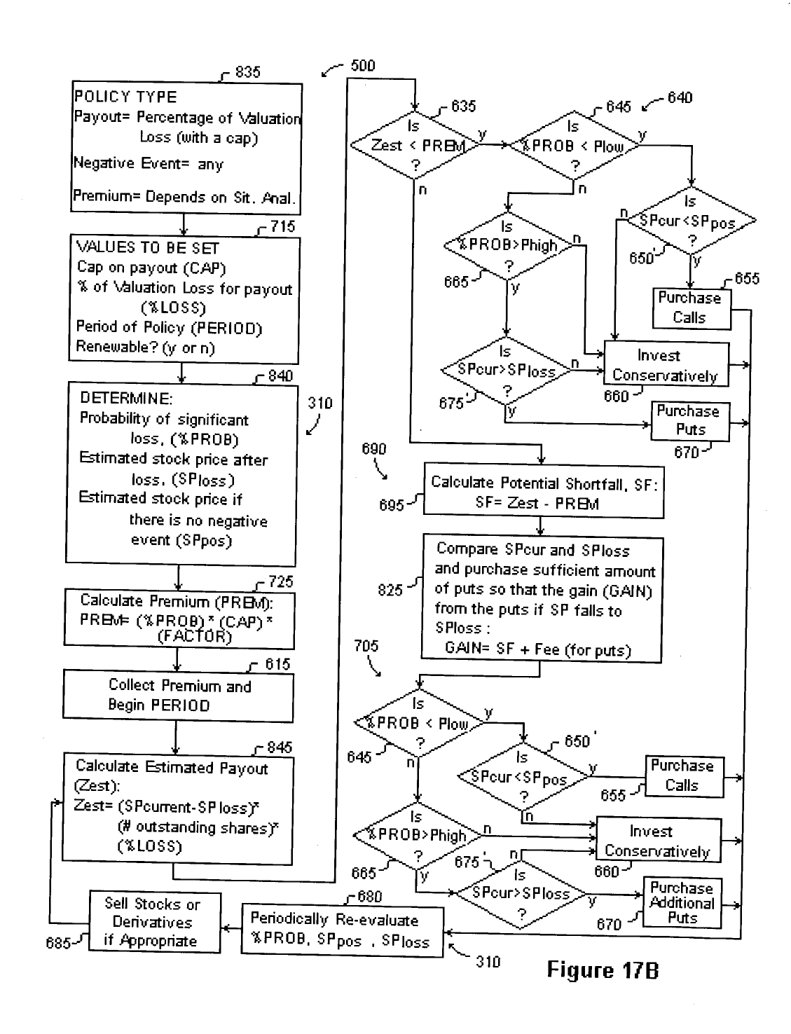

FIGS. 17A and 17B illustrate administration processes 500 associated with policies 810, 835 where no specific negative event is set forth. These processes are similar to the processes illustrated in FIGS. 13A and 13B, respectively, except that situational analysis 310 comprises determining 815, 840 the probability of significant loss (% PROB), such as a loss sufficient to amount to an insurance claim, the estimated stock price after such a loss (SPₗₒₛₛ), and the estimated stock price if there is no such negative event (SPₚₒₛ). Steps 820, 825, 830 are similar to Steps 630, 700, 680, respectively, but accounting for the situational analysis determinations, as is step 845. These policies may tend to be somewhat riskier and more difficult to analyze than others. Accordingly, the insurance provider may wish to install additional mechanisms for protecting against losses in the event of a payout.

The successfulness of providing protection of the type discussed above will be related to the accuracy of the situational analysis. Therefore, in one version, the situational analysis is performed by experts in fields that pertain to a particular company's business. For example, when analyzing a medical product company's situation, a team of experts may be composed of one or more scientists, one or more experts in regulatory matters, and/or one or more experts in finance.

The present method has usefulness in numerous industries. For example, the medical product industry where small companies often have a significant portion of their valuation based on one or a few products in development is an ideal application. In addition, other industries where a product requires a large investment and has a lengthy development time may benefit from a protection method of the type described above. Such industries include the automobile industry, the motion picture industry, the satellite industry, the computer industry, and the like.

One or more of the steps illustrated in the above examples may be implemented by a data processor, such as a computer or a controller. In particular, the data processor may be adapted to receive input values and to use the values to generate output values that may be used in determining the terms of an insurance policy and/or during the administration of an insurance policy. Although the data processor may be a single computer device, it should be understood that the data processor may be a plurality of computer devices that may be connected to one another.

In one embodiment, the data processor comprises electronic hardware including electrical circuitry comprising integrated circuits that is suitable for operating or controlling the protection providing method 300. Generally, the data processor is adapted to accept data input, run algorithms, and produce useful output signals. However, the data processor may merely perform one of these tasks. In one version, the data processor may comprise one or more of (i) a computer comprising a central processor unit (CPU) which is interconnected to a memory system with peripheral control components, (ii) application specific integrated circuits (ASICs) that operate particular components of the protection providing method 300 or operate a particular process, and (iii) one or more controller interface boards along with suitable support circuitry. Typical CPUs include the PowerPC™, Pentium™, and other such processors. The ASICs are designed and preprogrammed for particular tasks, such as retrieval of data and other information from an input device and/or operation of particular device components. Typical support circuitry includes for example, coprocessors, clock circuits, cache, power supplies and other well-known components that are in communication with the CPU. For example, the CPU often operates in conjunction with a random access memory (RAM), a read-only memory (ROM) and other storage devices well known in the art. The RAM can be used to store the software implementation of the present invention during process implementation. The programs and subroutines of the present invention are typically stored in mass storage devices and are recalled for temporary storage in RAM when being executed by the CPU.

The software implementation and computer program code product of the present invention may be stored in a memory device, such as an EPROM, and called into RAM during execution by the data processor. The computer program code may be written in conventional computer readable programming languages, such as for example, assembly language, C, C″, Pascal, or native assembly. Suitable program code is entered into a single file, or multiple files, using a conventional text editor and stored or embodied in a computer-usable medium, such as a memory of the computer system. If the entered code text is in a high level language, the code is compiled to a compiler code which is linked with an object code of precompiled windows library routines. To execute the linked and compiled object code, the system user invokes the object code, causing the computer system to load the code in memory to perform the tasks identified in the computer program. The data processor and program code described herein should not be limited to the specific embodiment of the program codes described herein or housed as shown herein, and other sets of program code or computer instructions that perform equivalent functions.

In one version, the data processor may interact with other data processors. For example, the data processors may interact over an internet connection. Accordingly, a central data processor may house algorithms necessary to implement one or more of the above described steps and an interacting data process may be able to input data for use in the algorithm and/or receive an output as a result of the running of the algorithms. In addition, the data processor may interact with other data processors to automatically control one or more of the steps of the processes discussed above. For example, the data processor may automatically and continuously purchase stocks and/or stock derivatives based on the values that input into it and/or based on monitoring of the stock situation.

Examples of data processors and data processing systems are disclosed in U.S. Pat. No. 6,018,714 and in U.S. Pat. No. 6,064,985, both of which are incorporated herein by reference in their entireties.

Thus, the present invention provides a manner in which a company may protect itself against a loss, such as a loss that is a result of a loss in its valuation. In addition, the present invention provides a manner in which a provider may provide such protection. Using the invention, the insured company may increase its financial strength, and the provider may generate revenue by providing the service.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, results of the situational analysis may be used to make investment strategies, such as those discussed above, even when an insurance policy is not provided to a company. In addition, when the expression “less than” is used, it may also mean, less than or equal to, significantly less than, or less than by a particular amount or percentage, “greater than” may mean greater than or equal to, significantly greater than, or greater than by a particular amount or percentage, and “equal to” may be significantly equal to or within a certain range. Also, when “stock price” is used, it is meant to also encompass, bond price for bonds, strike price for options, etc. Furthermore, certain terminology has been used for the purposes of descriptive clarity, and not to limit the present invention. Therefore, the invention should not be limited to the description of the preferred versions contained herein and should include all such alterations, permutations, and equivalents as fall within the true spirit and scope of the present invention.

What is claimed is:

1. A method of protecting a company, the method comprising:
providing an insurance policy to the company, the policy including terms whereby a payout may be paid to the company when the company suffers a predetermined loss in its valuation;
receiving a premium from the company; and
providing a payout to the company when the company undergoes the predetermined loss in its valuation.

2. A method according to claim 1 wherein the policy includes terms whereby the payout may be paid to the company when a specific negative event causes the company to suffer the predetermined loss in its valuation.

3. A method according to claim 1 wherein the policy includes terms whereby the payout may be paid to the company when any negative event causes the company to suffer the predetermined loss in its valuation.

4. A method according to claim 1 wherein the payout is provided to the company automatically when the company undergoes the predetermined loss in its valuation.

5. A method according to claim 1 wherein the payout is a predetermined amount.

6. A method according to claim 1 wherein the payout is related to the amount of the loss in the company's valuation.

7. A method according to claim 1 further comprising using at least a portion of the premium to purchase stocks and/or stock derivatives related to the company.

8. A method of protecting a company, the method comprising:
providing an insurance policy to a company,
performing a situational analysis on the company and using the results of the situational analysis to make investments, and
providing a payout to the company when the company undergoes a predetermined loss in its valuation.

9. A method according to claim 8 wherein the situational analysis comprises assessing the risk of the company undergoing the predetermined loss in its valuation.

10. A method according to claim 8 wherein the results of the situational analysis are used to calculate a premium associated with the policy.

11. A method according to claim 8 wherein the results of the situational analysis are used to purchase stocks and/or stock derivatives related to the company.

12. A method according to claim 11 wherein the stocks and/or stock derivatives related to the company are stocks and/or derivatives of the company.

13. A method according to claim 11 wherein the stocks and/or stock derivatives related to the company are stocks and/or derivatives of a company that competes with the company.

14. A method of protecting a company, the method comprising:
providing an insurance policy to a company,
performing a situational analysis,
receiving a premium from the company,
purchasing stocks and/or stock derivatives related to the company, and
providing a payout to the company when the company undergoes a predetermined loss in its valuation.

15. A method according to claim 14 wherein the situational analysis comprises assessing the risk of the company undergoing the predetermined loss in its valuation.

16. A method according to claim 15 wherein the stocks and/or stock derivatives related to the company are purchased in accordance with the assessed risk.

17. A method according to claim 14 wherein the situational analysis is performed before the premium is received and wherein the results of the situational analysis are used to calculate the amount of the premium.

18. A method according to claim 14 wherein the situational analysis is performed after the premium is received.

19. A method of protecting a company, the method comprising:
providing an insurance policy to a company,
performing a situational analysis,
determining the amount of potential payout,
purchasing one or more puts in the company, and
providing a payout to the company when the company undergoes a predetermined loss in its valuation.

20. A method according to claim 19 wherein the situational analysis comprises assessing the risk of the company undergoing the predetermined loss in its valuation.

21. A method according to claim 20 wherein the amount of puts purchased is related to the results of the situational analysis.

22. A method according to claim 19 wherein the amount of puts purchased is related to the amount of the payout.

23. A method according to claim 22 wherein the payout is a fixed amount.

24. A method according to claim 22 wherein the payout is related to the amount of the loss in valuation.

25. A method of providing protection for a company, the method comprising:
offering an insurance policy to a company, the policy including terms providing the company with a payout when the company undergoes a predetermined loss in its valuation,
determining a first valuation of the company,
determining a second valuation of the company, the second valuation being associated with a negative event,
determining a potential payout using the first and second valuations, and
purchasing puts associated with the company.

26. A method according to claim 25 wherein the amount of puts purchased is related to the potential payout.

27. A method according to claim 25 further comprising determining a likelihood of the actual valuation of the company becoming the second valuation.

28. A method according to claim 27 wherein the amount of puts purchased is related to the likelihood of the actual valuation of the company becoming the second valuation.

29. A method according to claim 25 wherein the puts are purchased so that the value of the puts would provide at least the potential payout in the event of the actual valuation of the company becoming the second valuation.

30. A method according to claim 25 further comprising receiving a premium from the company.

31. A method according to claim 30 wherein the puts are purchased so that the value of the puts would provide at least the difference between the potential payout and the premium in the event of the actual valuation of the company becoming the second valuation.

32. A method according to claim 25 wherein the company is a medical product company and wherein the negative event is the release of information related to the development of a particular medical product.

33. A method according to claim 33 wherein the medical product is a pharmaceutical product.

34. A data processing system for use in administering an insurance policy to protect a company from a loss in its valuation, the data processing system comprising:
means for inputting one or more values associated with the terms of the policy, at least one of the values being a predetermined amount of a loss in the company's valuation;
means for determining a premium based on the one or more input values, and
means for determining when a payout is due.

35. A data processing system according to claim 34 further comprising means for inputting or determining a company's actual loss in valuation.

36. A data processing system according to claim 35 further comprising means for determining the amount of payout based on the company's actual loss in valuation.

37. A data processing system for use in administering an insurance policy to protect a company from a loss in its valuation, the data processing system comprising:
means for inputting one or more values associated with the policy,
means for inputting one or more values associated with an analysis of the company,
means for determining investments to be made using the one or more values associated with an analysis of the company; and
means for determining when a payout is due based on a loss of valuation of the company.

38. A method according to claim 37 wherein the one or more values associated with an analysis of the company comprises one or more values related to an assessment of the risk of the company undergoing a predetermined loss in its valuation.

39. A method according to claim 37 further comprising means for determining a premium associated with the policy based on the one or more values associated with an analysis of the company.

40. A method according to claim 37 wherein the means for determining investments to be made comprises a means for determining the amount of stocks and/or stock derivatives related to the company that should be purchased.

41. A data processing system for use in administering an insurance policy to protect a company from a loss in its valuation, the data processing system comprising:
means for inputting one or more values associated with the policy,
means for inputting one or more values associated with an analysis of the company,
means for determining a premium based on one or more of the values,
means for determining a risk mitigating strategy based on one or more values associated with an analysis of the company, and
means for determining an amount of payout based on a loss of valuation of the company.

42. A data processing system according to claim 41 further comprising means for inputting or determining a first valuation of the company.

43. A data processing system according to claim 42 further comprising means or inputting, estimating, or determining a second valuation of the company, the second valuation being associated with a negative event.

44. A data processing system according to claim 43 wherein the means for determining an amount of payout uses the first and second valuations.

45. A data processing system according to claim 41 wherein the means for determining a risk mitigating strategy comprises a means for determining the amount of puts associated with the company to be purchased based on the means for determining a potential payout.
